(19) United States
(12) Patent Application Publication
(10) Pub. No.: US 2015/0304456 A1
(43) Pub. Date: Oct. 22, 2015

(54) METHOD AND SYSTEM FOR THE MANUFACTURE AND CREATION OF SURFACING MATERIALS

(71) Applicant: Wilsonart LLC, Temple, TX (US)

(72) Inventors: Arvind S. Karthikeyan, Temple, TX (US); Rajesh Ramamurthy, Temple, TX (US)

(21) Appl. No.: 14/693,242

(22) Filed: Apr. 22, 2015

Related U.S. Application Data
(60) Provisional application No. 61/982,766, filed on Apr. 22, 2014.

(51) Int. Cl. H04L 29/06; G06F 17/30

(52) U.S. Cl. CPC H04L 67/42; G06F 17/30312

(57) ABSTRACT

A system for the manufacture and creation of surfacing materials includes a central server maintaining operational software facilitating various functionalities. The central server functions in accordance with a client-server model where the central server coordinates provision of services and requests. The system also includes a design database linked to the central server, a manufacturing facility linked to the central server, a company website linked to the central server, design tools linked to the central server, input tools linked to the central server, and output tools linked to the central server.

### CROSS REFERENCE TO RELATE APPLICATION

This application claims the benefit of U.S. Provisional Application Ser. No. 61/982,766, filed Apr. 22, 2014, entitled “METHOD AND SYSTEM FOR THE MANUFACTURE AND CREATION OF SURFACING MATERIALS.”

### BACKGROUND OF THE INVENTION

1. Field of the Invention

The invention relates to surfacing materials. More particularly, the invention relates to a method and system for the manufacture and creation of surfacing materials.

2. Description of the Related Art

Decorative laminates are commonly constructed from plural layers of synthetic resin impregnated paper sheets bonded under heat and pressure to form a unitary structure. With regard to the manufacture of high pressure decorative laminates, the decorative laminate sheet assembly includes at least a core of one or more phenol formaldehyde resin impregnated sheets and a melamine impregnated decorative sheet. The decorative sheet may be further covered with a transparent melamine impregnated overlay layer.

The decorative sheet provides the laminate with an attractive appearance. The decorative sheet, and the overlay layer, dictate the surface characteristics of the decorative laminate. For example, the composition of the decorative sheet and overlay layer dictates the decorative laminate's resistance to chemical agents, heat, light, impact and abrasion. Decorative sheets are commonly manufactured from high quality 60-205 grams/meter², pigment filled, alpha cellulose paper impregnated with a water/alcohol or water solution of melamine-formaldehyde resin. The resin impregnated decorative sheets are subsequently dried, partially cured, and finally cut into sheets. The pigment filled, alpha cellulose paper of the decorative sheet may include a solid color, a decorative design, digital prints or a roto-gravure reproduction of natural materials, such as, wood, marble, leather, abstract design, etc. The aesthetic characteristics of the cellulose paper are revealed as the laminate's decorative design upon completion of the manufacture of the decorative laminate.

The advent of digital printing and other forms of customization have made it possible to provide the public with a virtually infinite number of choices from which to select the designs that will be imparted to a decorative sheet. With this in mind, the present system and method provide a mechanism facilitating the offering of such designs and the mechanisms for collecting and distributing such designs.

### SUMMARY OF THE INVENTION

It is, therefore, an object of the present invention to provide a system for the manufacture and creation of surfacing materials. The system includes a central server maintaining operational software facilitating various functionalities. The central server functions in accordance with a client-server model where the central server coordinates provision of services and requests. The system also includes a design database linked to the central server, a manufacturing facility linked to the central server, a company website linked to the central server, design tools linked to the central server, input tools linked to the central server, and output tools linked to the central server.

It is also an object of the present invention to provide a system for the manufacture and creation of surfacing materials wherein the design database is a repository of various designs which may be utilized in manufacture of surfacing materials.

It is another object of the present invention to provide a system for the manufacture and creation of surfacing materials wherein the manufacturing facility includes the structures, systems and processes employed in manufacture of surfacing materials.

It is a further object of the present invention to provide a system for the manufacture and creation of surfacing materials wherein the manufacturing facility includes the structures, systems and processes employed in manufacture of traditional high pressure decorative laminate.

It is also an object of the present invention to provide a system for the manufacture and creation of surfacing materials wherein the manufacturing facility provides for digital printing of small scale sheets of decorative paper used in the manufacture of high pressure decorative laminate.

It is another object of the present invention to provide a method for the manufacture and creation of surfacing materials. The method includes identifying a need for a new design for use in manufacture of surfacing materials, exploring existing designs maintained within the design database, reaching out to selected graphic artists for production and submission of designs to be used in manufacture of surfacing materials, reaching out to graphic artists from the public at large for production and submission of designs to be used in manufacture of surfacing materials, and periodically reviewing designs submitted by the selected graphic artists and the graphic artists from the public at large.

It is a further object of the present invention to provide a method for the manufacture and creation of surfacing materials wherein the step of reaching out to the selected graphic artists includes encouraging the selected graphic artists to access the central server via the company website and submit designs for inclusion within the design database.

It is also an object of the present invention to provide a method for the manufacture and creation of surfacing materials wherein the step of reaching out to the selected graphic artists includes providing royalty agreements from which the selected graphic artists may choose so as to protect intellectual property rights.

It is another object of the present invention to provide a method for the manufacture and creation of surfacing materials wherein the step of reaching out to the graphic artists from the public at large includes encouraging the graphic artists from the public at large to access the central server via the company website and submit designs for inclusion within the design database.

It is a further object of the present invention to provide a method for the manufacture and creation of surfacing materials wherein the step of reaching out to the graphic artists from the public at large includes providing royalty agreements from which the graphic artists from the public at large may choose so as to protect intellectual property rights.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a network diagram of the present system.

FIG. 2 is a schematic overview of the present system.

FIG. 3 is a flow chart showing operation of the present system.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as a basis for teaching one skilled in the art how to make and/or use the invention.

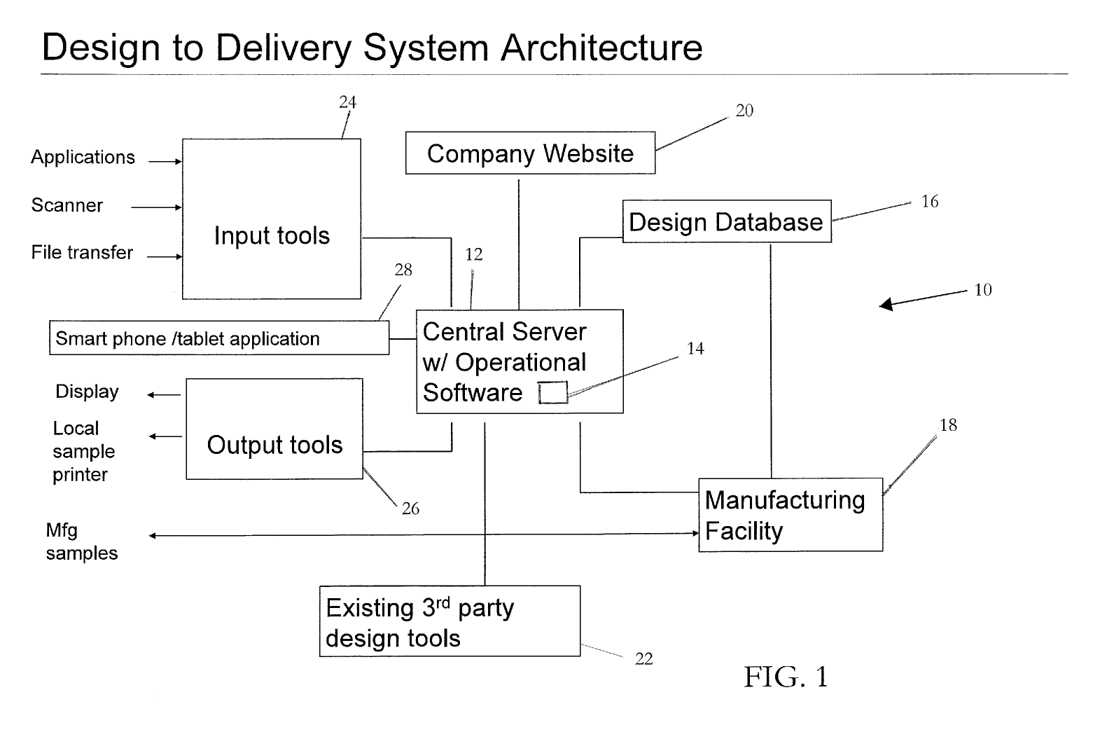

With reference to FIGS. 1, 2 and 3, a method and system for the manufacture and creation of surfacing materials is disclosed. The system 10 is designed for implementation in conjunction with a global communication network 100, and allows for the coordinated collection of designs. The designs are ultimately used in the manufacture of various surfacing materials, for example, high pressure decorative laminates.

It is appreciated high pressure decorative laminates are generally manufactured by stacking the resin impregnated core sheets, the decorative sheet and the overlay layer to form a laminate sheet assembly, or laminate lay-up. The laminate lay-up is placed between steel plates and subjected to temperatures in the range of about 121° C.-160° C., preferably 131° C., and pressure of about 56.24 kg/cm²-112.48 kg/cm², preferably 85 kg/cm², for a time sufficient to consolidate the laminate and cure the resins (generally about 25 minutes to an hour). The pressure and heat force the resin in the paper sheets to flow, cure and consolidate the sheets into a unitary laminated mass referred to in the art as a high pressure decorative laminate. Finally, the formed decorative laminate is bonded to a reinforcing substrate, such as, plywood, hardboard, asbestos board, particle board or the like.

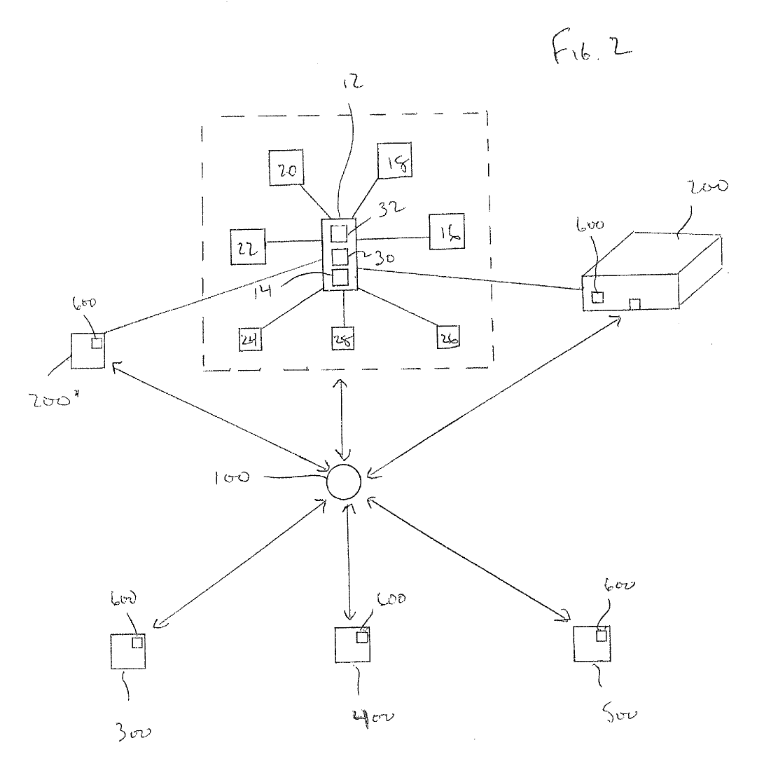

Referring to the network diagram and overview shown in FIGS. 1 and 2, at the core of the present system 10 is a central server 12 maintaining operational software 14 facilitating various functionalities described below in greater detail. The system 10, and ultimately the central server 12, are controlled and operated by an operator of the present system. In accordance with a preferred embodiment, the operator of the present system 10 is a large scale manufacturer 200 wishing to further expand potential design offerings, although it is appreciated the operator could be a third party operator 200′ to which others subscribe for use of the system 10. The central server 12 is linked to various elements of the present system 10 which allow for operation in accordance with the goals of the methodology contemplated herein. In particular, the central server 12 is linked to, and ultimately links together, a design database 16, a manufacturing facility 18, a company website 20, existing third party design tools 22, input tools 24, output tools 26 and various applications 28 which may be implemented with computer devices (for example, laptops, desktops, tablets, smartphones, and other computer based communication devices which allow for access with the central server 12 either directly or via a global communication network). It is appreciated the various components may be maintained within a single computer system operated and maintained by an operator of the present system 10 or the various components may be distributed throughout a network.

As disclosed above, the present system is implemented using various computer based systems which are implemented as programmable code for execution by such computer systems. After reading this description, a person skilled in the art would appreciate how to implement the invention using various computer systems and/or computer architectures.

As will be appreciated based upon the following disclosure, the central server 12 links the various elements and performs computer based functions ultimately resulting in the manufacture of custom surfacing materials. As those skilled in the art will appreciate, the central server 12 may take a variety of forms. The central server 12 functions in accordance with a client-server model where the central server 12 functions to coordinate the provision of services and requests amongst the various other elements making up the present system 10. In accordance with a preferred embodiment, the central server 12 will work in conjunction with the company website 20 that will serve as a front optimized to work and display color accurately on certain devices and running specialized applications used within the scope of this invention.

As mentioned above, the central server 12 is linked to a design database 16, a manufacturing facility 18, a company website 20, existing third party design tools 22, input tools 24, output tools 26 and various applications which may be implemented with computer devices 28. Considering first the design database 16, this is a repository of various designs which may be utilized in the manufacture of surfacing materials. The designs maintained within the design database 16 may take various forms. It is further appreciated, and as discussed below, the designs may be altered in various ways to accommodate the needs of specific consumers 300. For example, consumers desiring a specific color combination might alter the color palette employed within a design so as to accommodate their needs or consumers might alter elements relating to the texture (either actual physical texture or apparent visual texture) to achieve a desired look. In accordance with a preferred embodiment, the design database 16 is conventional database known to those skilled in the art.

Further considering the potential for consumers to alter the colors employed in a design to create unique colorations it is appreciated that technology exists to provide custom solutions for graphic processing and these techniques may be applied in the manufacture of high pressure decorative laminate in accordance with the present invention. The system 10 also employs a manufacturing facility 18 linked to the central server 12. The manufacturing facility generally includes the structures, systems and processes employed in the manufacture of decorative laminates or other surfacing materials. It is, therefore, appreciated such structures, systems and processes may vary depending upon the size, focus and complexity of an organization. In accordance with a preferred embodiment it is, however, contemplated the manufacturing facility 18 will allow for either traditional high pressure decorative laminate manufacture employing roto-gravure printing of large scale rolls of decorative paper or digital printing of small scale sheets of decorative paper. The manufacturing facility 18 might also allow for the implementation of alternate digital printing systems used in the manufacture of surfacing materials.

For example, the manufacture of surfacing materials in accordance with such a digital printing system would be achieved in the following manner and as explained in detail in U.S. patent application Ser. No. 13/954,199, entitled “PRINTED LAMINATE WITH DIGITAL PRINTING AND METHOD FOR MANUFACTURE”, filed Jul. 30, 2013, which is incorporated herein by reference. A design is first selected from the design database. A substrate of medium density fiberboard is then pre-treated with the application of a UV cured adhesion promoter layer. Thereafter, a filler layer is applied over the adhesion promoter layer. The filler is applied in multiple layers to a coat weight as needed to fill pores and surface imperfections.

Once the substrate is pre-treated with the adhesion promoter layer and the filler layer, the priming layer is applied. In accordance with a preferred embodiment, the priming layer is composed of a white UV cured acrylic and it is applied to a coat weight necessary to fully cover the pre-treated substrate. As the pre-treated substrate will exhibit different surface characteristics, the coat weight of the UV cured acrylic that must be applied to achieve a desired surface for printing will vary.

The primed substrate is then ready for digitally printing. The design imprinted thereon is that selected at the initial stage. Once the substrate is primed and printed, the top coat layer is applied thereto. The top coat layer in accordance with a preferred embodiment of the present invention includes a first top coat layer of clear hot melt polyurethane and a second top coat layer of clear UV cured acrylic. The coat weight of the clear hot melt polyurethane first top coat layer determines various functional characteristics of the final product and these characteristics are ultimately balanced in determining the coat weight of the clear hot melt polyurethane first top coat layer applied to the primed and printed substrate.

Thereafter, a clear UV cured acrylic second top coat layer is applied to the clear hot melt polyurethane first top coat layer. The resulting product is fully cured and the decorative laminate is ready for use. Although a preferred printing methodology is described above, it is appreciated the present invention may be implemented via UV ink based digital printing on a variety of substrates, such as, chipboard, medium density fiberboard (MDF), plywood, particle board, veneers, concrete, fiberglass reinforced panels and melamine faced chipboard.

As discussed above, the surfacing material produced by the methodology described above employs a design selected from a vast array of designs populating the design database of the present system. The remaining elements of the system provide the various tools allowing for the population of the design database from which consumers may select for the manufacture of surfacing materials.

The company website 20 is a traditional corporate website but includes links to the central server 12 for utilization of the present method and system 10. As will be appreciated in consideration of the exemplary implementation of the present system 10, the company website 20 allows access for the submission of designs to both selected graphic artists 400 specifically selected by the operator 200, 200′ of the present system 10 and by graphic artists from the public at large 500. It is appreciated submissions by selected graphic artists 400 specifically selected by the operator 200, 200′ of the present system 10 will precede graphic artists from the public at large 500 to ensure the designs received are relevant and similar to ones currently maintained in the design database 16. The central server 12 may be accessed by large scale manufacturers 200 (for example, the company operating the system 10 or those subscribing to a third party operator 200′) wishing to identify designs for mass production, consumers 300 wishing to select designs for use in their personal manufacture of surfacing materials, selected graphic artists 400 selected by the operator 200, 200′, and/or graphic artists from the public at large 500 wishing to submit designs for inclusion within the design database 16. The central server 12 may similarly be accessed by consumers/graphic artists wishing to apply their own designs in the manufacture of surfacing materials.

With this in mind, the central server 12 provides various output tools 26 and input tools 24 for use by large scale manufacturers 200, consumers 300, selected graphic artists 400 selected by the operator 200, 200′, and/or graphic artists from the public at large 500. Ultimately, the output tools 26 and the input tools 24 are implemented using computer devices 600 (for example, laptops, desktops, tablets, smartphones, and other computer based communication devices which allow for access with the central server 12 either directly or via the global communication network 100). As such, the central server 12 provides a graphical user interface 30 facilitating convenient use of the output tools 26 and input tools 24. The graphical user interface 30 allows the large scale manufacturers 200, consumers 300, selected graphic artists 400 selected by the operator 200, 200′, and/or graphic artists from the public at large 500 to take advantage of various input technologies including, but not limited to, applications, scanners and file transfer which allow large scale manufacturers 200, consumers 300, selected graphic artists 400 selected by the operator 200, 200′, and/or graphic artists from the public at large 500 to upload information to the central server 12 for processing in accordance with the present invention.

It is appreciated a variety of known file sharing/upload protocols exist and may be employed in accordance with the present invention. For example, protocols such as Plan 9 Filesystem Protocol (9P), Apple Filing Protocol (AFP), BitTorrent, Infinit, File Transfer Access and Management (FTAM), File Transfer Protocol (FTP), FTP over the Secure Sockets Layer (FTPS), HFTP, Hypertext Transfer Protocol (HTTP), HTTP Secure (HTTPS), Web Distributed Authoring and Versioning (WebDAV), rcp (remote-copy, allowing files to be copied over the network), rsync, Simple Asynchronous File Transfer (SAFT), bound to Transmission Control Protocol (TCP) port 487, Secure copy (SCP), SSH (Secure Shell) file transfer protocol (SFTP), Simple File Transfer Protocol and T.127 may be employed in accordance with the present invention.

In conjunction with the use of output tools 26 and input tools 24, the operator 200, 200′ of the present system 10 will specify a list of requirements with which the submitted files need to conform, for example, file size, type, resolution etc. It is appreciated the files will tend to be large in size and will have to be uploaded from a computer 600. The uploaded files will be checked and processed internally by graphic artists and multiple color versions will be created. It is further appreciated some designs could be selected for specialized collection(s) marketed by a large scale manufacturer 200.

The graphical user interface 30 also allows large scale manufacturers 200, consumers 300, selected graphic artists 400 selected by the operator 200, 200′, and/or graphic artists from the public at large 500 to take advantage of various output technologies including, but not limited to, displays of various designs, the ability to visualize selected designs on various products and the ability to locally print samples of a design for further evaluation. It is appreciated files may be downloaded in small preview sizes to be printed locally by anyone with access to the website 20. However, implementing International Color Consortium color management is a must to ensure correct color in the printed samples. However, the colors achievable will be dependent on the printers and the materials used for printing. The operator 200, 200′ will allow customers to order samples that are of the correct color in the website 20. Output formats will be limited to samples and print outs from the website 20.

More specifically, and considering the various input and output tools 24, 26 contemplated for use in conjunction with the present system 10, many of these are conventional input and output tools, for example, scanner, file transfer, and printers. However, some tools are specific to the present system 10. For example, the present system offers various applications 28 allowing for image processing specific to the present methodology. Such image processing applications will allow large scale manufacturers 200, consumers 300, selected graphic artists 400 selected by the operator 200, 200′, and/or graphic artists from the public at large 500 to alter designs in desirable ways and visualize the altered designs for further evaluation. It is appreciated that one of the current challenges is the inability to design a robust system for viewing color accurately without requiring investment in time, money or know-how from a customer. It is contemplated that tablets, such as iPads, having consistent color rendering capabilities may be implemented in accordance with the present invention. Such tablets would serve as devices that could be used to view designs in accurate color. As such, the digital files will be prepared specially to display color accurately on such tablets. It is also appreciated that an application will be provided allowing one to ensure current digital files are properly color managed so that they perform optimally on mobile devices like tablets and smartphones.

The central server 12 may also be accessed using various third party design tools 22. In accordance with a preferred embodiment, files will be required to be of a predetermined format, for example, an Adobe supported file format. The files could be prepared using Adobe or similar applications. In addition, the website will be optimized to work with FTP (File Transfer Protocol), SMB (Server Message Block) or other file sharing protocols to enable easy file transfer.

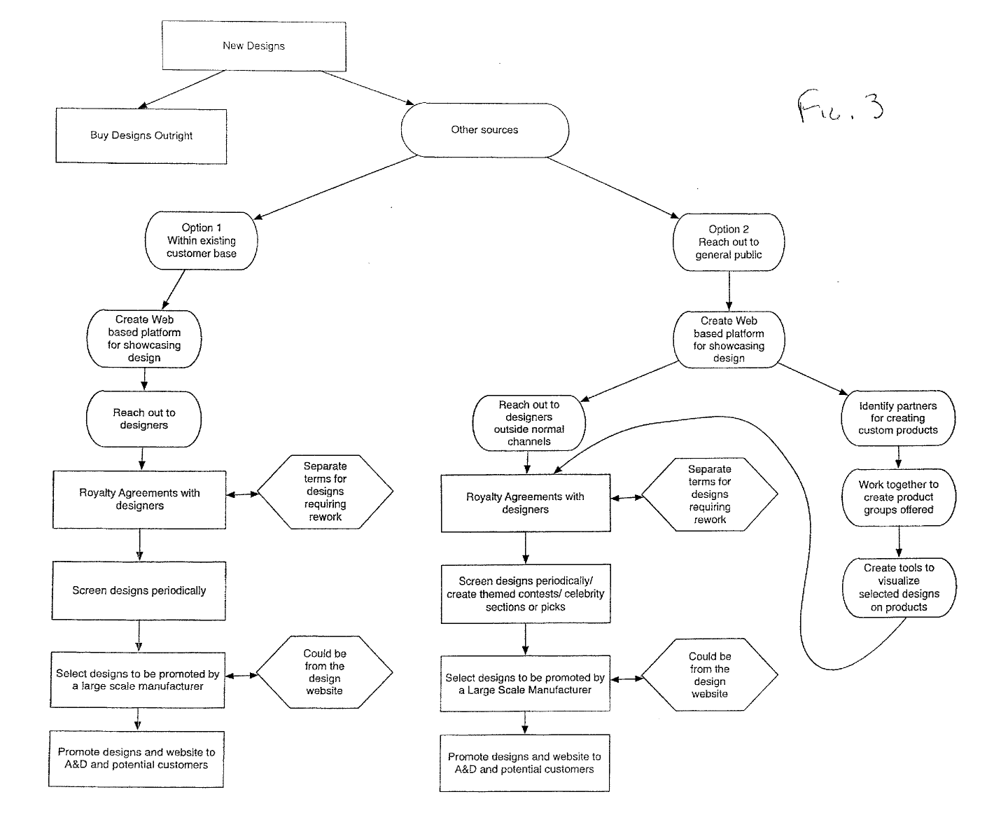

With these tools and elements of the present system 10 in mind, reference is made to FIG. 3 where an exemplary method for implementation thereof is disclosed. The method begins with a large scale manufacturer's 200 need for a new design(s) for use in the manufacture of surfacing materials. Once the large scale manufacturer identifies the need for a new design for use in the manufacture of surfacing materials, they may either buy the new design outright from a third party or they may employ the present system 10. Where it is determined the new design will be purchased from a third party, the transaction is achieved in a traditional manner.

Where, however, the present system 10 is implemented, the large scale manufacturer 200 may first explore existing designs maintained within the design database 16. It is contemplated designs will be sorted by inspirations (food, shapes, patterns, wood, stone) and also by color. There may also be special collection(s) maintained by the large scale manufacturer 200 (which in accordance with the present embodiment is the operator of the system). There could also be a section of promoted items like a portfolio by designer x or endorsed by celebrity y. If a desired design is not found within the design database 16, the system 10 may be used to reach out to selected graphic artists 400 (for example, contacting the selected graphic artists 400 via email, text message, or other communication methodology) for the production and submission of designs to be used in the manufacture of surfacing materials. The selected graphic artists 400 are encouraged to access the central server 12 via the company website 20 and submit their designs for inclusion within the design database 16. As such, there will be a section where the remuneration terms for certain specific designs will be higher than the others.

In addition to utilizing the input tools 24 and the output tools 26 for the submission of designs, the central server 12 is further provided with various royalty agreements 32 (applicable to the specifics of the selected graphic artist's situation) from which the selected graphic artist 400 may choose so as to protect intellectual property rights in any design he/she might submit. The agreements may range from assignments of a design to non-exclusive or exclusive licenses to use the design for very limited purposes.

As the designs are submitted by selected graphic artists 400, they are periodically reviewed and decisions are made by the company operating the system 10 regarding which of the designs will be further promoted for commercial development. While such an implementation by selected graphic artists contemplates reaching out to graphic artists who are not previously under contract with the large scale manufacturer or the operator, it is appreciated such submissions may be made by those graphic artists previously contracted by the large scale manufacturer or the operator, as well as employees of the large scale manufacturer or the operator.

It is also contemplated the present system 10 may be used to reach out to graphic artists from the public at large 500 (for example, contacting the graphic artists from the public at large 500 via email, text message, or other communication methodology) for the production and submission of designs to be used in the manufacture of surfacing materials. As with the selected graphic artists 400 selected by the operator 200, 200′, the graphic artists from the public at large 500 are encouraged to access the central server 12 via the company website 20 and submit their designs for inclusion within the design database 16. Such encouragement might be achieved using a marketing campaign focused upon graphic artists from the public at large 500 to inform and encourage designers to become part of the program in accordance with the present invention.

As the graphic artists from the public at large 500 submit designs, these submissions will populate the design database 16. Ultimately, these designs will be used to identify partners for creating custom products wherein the identified partners will work with the large scale manufacturer 200 to create product groups. In conjunction with this creation process, the central server 12 offers tools for visualizing selected designs on various products. The submitted designs will be curated by a design team and/or by other designers. The collection will be selected and will be put through the same process of filtering conventional designs through creating samples and small runs.

Regardless of whether the graphic artists from the public at large 500 are simply submitted for review and potential use or whether the large scale manufacturer 200 interacts with the graphic artists from the public at large 500 to create products, the central server 12 provides various royalty agreements 32 (applicable to the specifics of the graphic artist's situation) from which the graphic artists from the public at large 500 may choose so as to protect their intellectual property rights in any design they might submit. The agreements may range from assignments of a design to non-exclusive or exclusive licenses to use the design for very limited purposes. As with the designs submitted by selected graphic artists 400 selected by the large scale manufacturer 200, the designs from graphic artists from the public at large 500 are periodically reviewed and decisions are made by the large scale manufacturer 200 regarding which of the designs will be further promoted for commercial development.

With the vast array of designs developed, created, and submitted in accordance with the present invention, a wide variety of products will likely result. Such a system will ultimately provide the consuming public with a new array of choices as they identify their surfacing needs.

While the preferred embodiments have been shown and described, it will be understood that there is no intent to limit the invention by such disclosure, but rather, is intended to cover all modifications and alternate constructions falling within the spirit and scope of the invention.

1. A system for the manufacture and creation of surfacing materials, comprising:
a central server maintaining operational software facilitating various functionalities, the central server functioning in accordance with a client-server model where the central server coordinates provision of services and requests;
a design database linked to the central server;
a manufacturing facility linked to the central server;
a company website linked to the central server;
design tools linked to the central server;
input tools linked to the central server; and
output tools linked to the central server.

2. The system for the manufacture and creation of surfacing materials according to claim 1, wherein the design database is a repository of various designs which may be utilized in manufacture of surfacing materials.

3. The system for the manufacture and creation of surfacing materials according to claim 1, wherein the manufacturing facility includes the structures, systems and processes employed in manufacture of surfacing materials.

4. The system for the manufacture and creation of surfacing materials according to claim 3, wherein the manufacturing facility includes the structures, systems and processes employed in manufacture of traditional high pressure decorative laminate.

5. The system for the manufacture and creation of surfacing materials according to claim 3, wherein the manufacturing facility provides for digital printing of small scale sheets of decorative paper used in the manufacture of high pressure decorative laminate.

6. A method for the manufacture and creation of surfacing materials implemented using a system comprising a central server maintaining operational software facilitating various functionalities, the central server functioning in accordance with a client-server model where the central server coordinates provision of services and requests, a design database linked to the central server, a manufacturing facility linked to the central server, a company website linked to the central server, design tools linked to the central server, input tools linked to the central server and output tools linked to the central server, the method comprising:
identifying a need for a new design for use in manufacture of surfacing materials;
exploring existing designs maintained within the design database;
reaching out to selected graphic artists for production and submission of designs to be used in manufacture of surfacing materials;
reaching out to graphic artists from public at large for production and submission of designs to be used in manufacture of surfacing materials;
periodically reviewing designs submitted by the selected graphic artists and the graphic artists from the public at large.

7. The method for the manufacture and creation of surfacing materials according to claim 6, wherein the step of reaching out to the selected graphic artists includes encouraging the selected graphic artists to access the central server via the company website and submit designs for inclusion within the design database.

8. The method for the manufacture and creation of surfacing materials according to claim 7, wherein the step of reaching out to the selected graphic artists includes providing royalty agreements from which the selected graphic artists may choose so as to protect intellectually property rights.

9. The method for the manufacture and creation of surfacing materials according to claim 6, wherein the step of reaching out to the graphic artists from the public at large includes encouraging the graphic artists from the public at large to access the central server via the company website and submit designs for inclusion within the design database.

10. The method for the manufacture and creation of surfacing materials according to claim 9, wherein the step of reaching out to the graphic artists from the public at large includes providing royalty agreements from which the graphic artists from the public at large may choose so as to protect intellectually property rights.
